(19) United States
(12) Patent Application Publication
(10) Pub. No.: US 2019/0311117 A1
(43) Pub. Date: Oct. 10, 2019

(54) EMPLOYING CODE SIGNING AS A TOOL IN CYBER-SECURITY DECEPTION

(71) Applicant: Cymmetria, Inc., Palo Alto, CA (US)

(72) Inventors: Dean SYSMAN, Haifa (IL); Imri GOLDBERG, Kfar-Netter (IL); Itamar SHER, Kiryat-Tivon (IL); Jonathan PERRY, Pardesia (IL); Shmuel UR, Shorashim (IL)

(73) Assignee: Cymmetria, Inc., Palo Alto, CA (US)

(21) Appl. No.: 16/309,487

(22) PCT Filed: Jun. 14, 2017
(86) PCT No.: PCT/IB2017/053523

§ 371 Date: Dec. 13, 2018

Related U.S. Application Data
(60) Provisional application No. 62/349,746, filed on Jun. 14, 2016.

(51) Int. Cl. G06F 21/56; G06F 21/12; G06F 21/53; G06F 21/57; G06F 21/55

(52) U.S. Cl. CPC G06F 21/56; G06F 21/121; G06F 21/554; G06F 21/57; G06F 21/53

(57) ABSTRACT

A computer implemented method of detecting execution of unregistered code in a protected networked system, comprising maintaining a pages registry record in a storage of an endpoint in a protected networked system, the pages registry record comprising a registration signature for each of a plurality of registered executable pages, monitoring a plurality of executable pages at a page management level using an adjusted page fault handler of an operating system kernel executed by one or more processors of the endpoint, detecting one or more unregistered executable pages by identifying incompliance of a runtime signature calculated in runtime for the unregistered executable page(s) with respective registration signature stored in the pages registry record and initiating one or more actions in case of the detection of the unregistered executable page(s).

### RELATED APPLICATIONS

This application claims the benefit of priority under 35 USC 119(e) of U.S. Provisional Patent Application No. 62/349,746 entitled “Method for Employing Code Signing as a Tool in Cyber-Security Deception” filed Jun. 14, 2016, the contents of which are incorporated herein by reference in their entirety.

### BACKGROUND

The present invention, in some embodiments thereof, relates to detecting execution of unregistered (unsigned) code in a protected networked system, and, more specifically, but not exclusively, to detecting execution of unregistered code in a protected networked system by maintaining a pages registry and checking compliance of executable code pages with the pages registry.

Code signing is the process of digitally signing executable code segments, such as, for example, applications, agents, tools, scripts and/or the like to confirm the software author and guarantee that the code is authentic, i.e. has not been altered or corrupted since it was signed. The process may employ the use of a cryptographic hash to validate authenticity and/or integrity of the signed software code.

Code signing may provide several valuable features, for example, provide security for execution of the code, prevent namespace conflicts, track invocations and/or execution of specific code segments of interest and/or the like.

Typically, code signing provides some sort of digital signature mechanism to verify the identity of the author, the build system, and a checksum to verify that the executable object has not been modified. The signature may also provide versioning information about an executable object or be used to store metadata relating to the executable object.

### SUMMARY

According to a first aspect of the present invention there is provided a computer implemented method of detecting execution of unregistered code in a protected networked system, comprising:
Maintaining a pages registry record in a storage of an endpoint in a protected networked system, the pages registry record comprising a registration signature for each of a plurality of registered executable pages.
Monitoring a plurality of executable pages at a page management level using an adjusted page fault handler of an operating system kernel executed by one or more processors of the endpoint. The page fault handler prepares each of the plurality of executable pages for execution by the processor(s).
Detecting one or more unregistered executable pages by identifying incompliance of a runtime signature calculated in runtime for the unregistered executable page(s) with respective registration signature stored in the pages registry record.
Initiating one or more actions in case of the detection of the unregistered executable page(s).

Monitoring and detecting the unregistered code at the page level may allow runtime detection since the page size is finite and typically small. Moreover, monitoring and detecting the unregistered executable pages at the page level may allow detection of alterations to the code as may be done, for example, by the self-changing code and/or by malicious code altering previously registered executable pages. Based on the detected unregistered executable pages, one or more actions may be taken as predefined in the protected networked system.

According to a second aspect of the present invention there is provided a system for detecting execution of unregistered code in a protected networked system, comprising a storage storing a code storing a pages registry record comprising a registration signature for each of a plurality of registered executable pages and one or more processors of an endpoint in a protected networked system. The processor(s) is coupled to the storage for executing the stored code, the code comprising:
Code instructions to monitor a plurality of executable pages at a page management level using an adjusted page fault handler of an operating system kernel executed by the processor(s). The page fault handler prepares each of the plurality of executable pages for execution by the processor(s).
Code instructions to detect one or more unregistered executable pages by identifying incompliance of a runtime signature calculated in runtime for the unregistered executable page(s) with respective registration signature stored in the pages registry record.
Code instructions to initiate one or more actions in case of the detection of the unregistered executable page(s).

In a further implementation form of the first and/or second aspects, the plurality of registered executable pages are identified by parsing a plurality of executable code segments of a plurality of software modules approved for execution in the protected network. This may allow for efficient detection of the software code base approved for each of the endpoints in order to properly register the approved code.

In a further implementation form of the first and/or second aspects, the registration signature of each of the plurality of registered executable pages comprises at least identification (ID) of a respective one of the plurality of registered executable pages and an authentication value calculated by applying one or more hash functions to the respective executable page. Creating the registration signature allows to uniquely identify each of the registered executable pages approved for execution at the endpoint(s) of the protected networked system. Moreover, the content of each of the registered executable pages may be assigned with the specifically calculated authentication value which thus uniquely identifies the contents. Using fast authentication algorithms such as the hash functions (e.g. SHA-1, SHA-256, etc.) may further complement the page level detection as such hash functions may allow for fast and efficient generation of the authentication (hash) to avoid performance degradation.

In a further implementation form of the first and/or second aspects, the detecting and the initiating is controlled by an adjusted page fault handler replacing a page fault handler of the operating system. In order to enable the page level monitoring, detecting and action initiation, the original page fault handler may be adjusted to include the additional functionality. The adjusted page fault handler may be implemented by adjusting and/or adapting the original page fault handler. Additionally and/or alternatively, the adjusted page fault handler may replace the original page fault handler by hooking the adjusted page fault handler to the physical layer page fault interrupt instead of the originally hooked original page fault handler

In a further implementation form of the first and/or second aspects, the incompliance comprises—absence of an ID of the unregistered executable page(s) in the pages registry record and/or an authentication value in the runtime signature not matching the authentication value in the respective registration signature. The compliance of each executable page is verified by matching the runtime signature in the pages registry record. This means that the ID of a respective executable page is first searched in the pages registry record. In case the ID is not found, the respective executable page is obviously incompliant and may be identified as an unregistered executable page. In case the ID of the respective executable page is found in the pages registry record, the respective executable page may be registered. However, it must be verified that the contents of the respective executable page has not changed since its registration. This is done by comparing the authentication value calculated in runtime (included in the runtime signature) with the authentication value associated with the matching ID in the pages registry record.

In an optional implementation form of the first and/or second aspects, execution privileges are removed from one or more of the plurality of executable pages as part of the maintaining. Removing the execution privileges from the executable pages during the registration phase may force a page fault event during a following runtime execution which will trigger the adjusted page fault handler to perform the monitoring of the executable pages to detect the unregistered executable page(s). In addition, removing the execution privileges may allow further control over the execution flow of the executable pages, such that only after properly identified and verified or detected as unregistered, each page may be executed.

In an optional implementation form of the first and/or second aspects, the execution privileges are granted to the executable pages after the identifying. Granting the execution privileges to the executable pages may be done to allow the proper execution of the executable pages after these privileges were previously removed.

In an optional implementation form of the first and/or second aspects, write privileges are removed from one or more of the plurality of executable pages prior to the execution. The write privileges may be removed in order to prevent scenarios in which an originally registered executable page may be altered in runtime to include different content and potentially different executable code.

In a further implementation form of the first and/or second aspects, the one or more actions comprise generating an alert, monitoring execution activity of the unregistered executable page(s) and/or preventing execution of the unregistered executable page(s). the actions to be taken upon detection of the unregistered executable page(s) may depend on the protected networked system settings, nature, objective and/or the like and may therefore be predefined per each protected networked system.

In an optional implementation form of the first and/or second aspects, the pages registry record is updated with the registration signature generated for one or more executable pages of one or more approved software modules added to the protected networked system. This allows adding new approved software code after the approved software is already deployed to the endpoint(s).

In an optional implementation form of the first and/or second aspects, a plurality of detection events, in which the unregistered executable page(s) is detected, are logged. Collecting the execution data, for example, context of execution, frequency of execution, timing of execution and/or the like which may be used for further statistical analysis.

In an optional implementation form of the first and/or second aspects, the plurality of detection events is analyzed to identify one or more execution patterns of the unregistered executable page(s). Identifying the execution patterns may serve for a plurality of applications and/or uses, for example, detection of potential cyber-security threats, detection of bugs in software code, improve software code utilization and/or the like.

In a further implementation form of the first and/or second aspects, the endpoint is a member of a group consisting of: a physical device comprising one or more processors and a virtual machine. This may allow a plurality of different and various types of endpoints and practically every endpoint in the protected networked system to employ the runtime detection of the unregistered software code.

In a further implementation form of the first and/or second aspects, the endpoint is a decoy endpoint adapted to maintain a deception environment of the protected networked system. Runtime detection of the unregistered executable pages which may potentially be malicious executable pages may be of great benefit for decoy endpoints in which the execution of the unregistered executable pages may be closely monitored and tracked while uninterrupted in order not to alert a potential attacker of the fact he is detected. As such, the unregistered executable pages may execute normally while their execution activity is monitored to collect forensic data that may be analyzed to characterize potential malicious attackers, identify attack vectors and/or the like.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced

In the drawings:

FIG. 1 is a flowchart of an exemplary process of detecting execution of unregistered code in a protected networked system, according to some embodiments of the present invention; and

FIG. 2 is a schematic illustration of an exemplary system for detecting execution of unregistered code in a protected networked system, according to some embodiments of the present invention.

### DETAILED DESCRIPTION

The present invention, in some embodiments thereof, relates to detecting execution of unregistered (unsigned) code in a protected networked system, and, more specifically, but not exclusively, to detecting execution of unregistered code in a protected networked system by maintaining a pages registry and checking compliance of executable code pages with the pages registry.

According to some embodiments of the present invention, there are provided methods, systems and computer program products for detecting execution of unregistered (i.e. unsigned), and as such potentially unapproved, software code in a protected networked system by marking executable entities at page level and monitoring execution of the executable pages to detect unregistered code execution. Marking, monitoring and detecting at page level relates to marking, monitoring and detecting execution of executable pages which are the smallest executable software code entities. The size of the executable page is defined and/or set according to one or more characteristics of the execution environment, for example, the hardware execution platform (e.g. processor, cache and/or memory architecture), Operating System (OS) execution environment and/or the like.

An approved software code base comprising one or more software modules, for example, OSs, applications, agents, tools, services, scripts and/or the like may be defined for one or more endpoints in the protected networked system, for example, an organization network, an institution network and/or the like. The endpoints may by physical processing nodes (physical device), for example, a computer, a workstation, a server, a cluster of processing nodes, a network node, a Smartphone, a tablet, a modem, a hub, a bridge, a switch, a router, a printer and/or any network connected device having one or more processors. The endpoints may further include virtual devices, for example, a Virtual Machine (VM) executed by one or more of the processing nodes to provide an abstracted and platform-dependent and/or independent program execution environment. The approved software base is naturally controlled by the operator(s) of the protected networked system and is therefore assumed to be trusted and reliable. The approved software base is also assumed to be free of potential malicious software code.

In a preliminary registration (signing) phase, the approved software code is registered. The approved software code may be analyzed, for example, by traversing the file system of each of the endpoints, to identify a plurality of executable code segments and further identify the plurality of executable pages constituting the executable code segments. Once identified, a registration signature may be generated for each of the executable pages and/or for subsets of executable pages thus designating them as registered executable pages. The registration signature may include, for example, identification (ID) of a respective registered executable page and an authentication value associated with the specific content of the respective registered executable page. The authentication value, for example, a checksum may be used to verify the respective registered executable page has not been altered, changed, manipulated and/or the like since it was registered. The authentication value may be generated using, for example, one or more hash functions to create a hash value that may be uniquely associated with the exact content of the respective registered executable page. The registration signatures are updated in a pages registry record, for example, a database, a list, a table and/or the like which is stored in the protected networked system.

During runtime, at each of the endpoints, a plurality of executable pages are monitored at the page management level using an adjusted page fault handler replacing an original page fault handler in a kernel of an OS executed by the endpoint. The page fault routine may be triggered whenever a page fault event is detected in which an executable page that needs to be executed is not currently mapped for execution by the Memory Management Unit (MMU) of the endpoint's processor(s) into the virtual address space of the executing software module. The page fault handler may therefore prepare the requested executable page for execution by creating an entry for the requested executable page in the MMU to point to the page in memory and indicate that the page is loaded and available for execution in memory. The adjusted page fault handler may be implemented by adjusting and/or adapting the original page fault handler. Optionally, the adjusted page fault handler may replace the original page fault handler in the kernel by hooking the adjusted page fault handler to the physical layer page fault interrupt (e.g. vector 14 for Intel x86 architecture) instead of the originally hooked original page fault handler. While loading the executable pages, mapping them and/or preparing them for execution, the adjusted page fault handler may generate a runtime signature for each of the executable pages and/or for each of the subsets of executable page. The structure of the runtime signature follows the same structure and content as the registration signature. Naturally, during runtime, the adjusted page fault handler applies the same authentication value generation method, for example, using the same hash function(s) to calculate the runtime hash value as is used to calculate the hash values in the registration signatures during the registration phase.

The adjusted page fault handler may check whether each of the monitored executable pages is a registered executable page by checking for a match of the runtime calculated signature to the registration signature(s) stored in the pages registry record. The match indicates that a matching registration signature is found in the pages registry record having the same ID and an equal authentication value as the value calculated for the runtime signature. Based on the matching results, the monitored executable page may be determined to be in compliance or in incompliance with respective registration signatures in the pages registry record.

In case the runtime signature of a respective executable page matches one of the registration signatures in the pages registry record, the respective executable page is considered as approved executable page and may execute normally. However in case the runtime signature of the respective executable page does not match any of the registration signatures in the pages registry record, the respective executable page is identified as an unregistered executable page. In case of incompliance, one or more actions may be taken as predefined for the protected networked system, for example, generate an alert, monitor execution activity of the unregistered executable page, prevent execution of the unregistered executable page and/or the like.

Optionally, access privileges, for example, execution and/or write privileges are granted and/or denied for the executable pages during one or more phases of the process in order to force a page fault event and trigger the adjusted page fault handler. The access privileges may also be removed from the executable page(s) to prevent uncontrolled execution in the protected networked system execution environment. For example, the execution privileges may be removed from a certain registered executable page during the registration phase such that during runtime, when trying to execute that registered executable page, execution may fail due to lack of execution privileges for the certain registered executable page. The adjusted page fault handler may therefore be triggered to conduct the monitor, generate the runtime signature for the certain registered executable page and check for compliance or incompliance of the certain registered executable page.

Optionally, the detection events of the unregistered executable page(s) are logged and stored. The logs may be further analyzed to identify one or more execution patterns of the unregistered executable page(s), for example, context of execution, frequency of execution, timing of execution and/or the like. Such statistical analysis may serve for a plurality of purposes, for example, monitoring execution of specific software modules, logging invocations and/or execution events of pay-per-use software modules, debugging software modules, validating software modules and/or the like.

In some embodiments of the present invention, one or more of the endpoints in the protected networked system is a decoy endpoint which may create, maintain and/or adapt a deception environment within the protected networked system to emulate a genuine (real) processing environment of the protected networked system. Monitoring the executable pages and identifying the unregistered executable pages may be of particular benefit for such a decoy endpoint in order to detect malicious code execution and potential exposure of the protected networked system to a cyber-attack. While the approved software code comprises verified code and may therefore not include malicious code, the identified unregistered executable page(s) may potentially be malicious code pages. The objective of the decoy endpoint(s) may be to contain the activity of the malicious attacker and as such while allowing the unregistered executable page(s) to execute normally and lead the attacker to believe he is not detected, one or more additional actions may be taken, for example, generating an alert, monitoring execution activity of the respective unregistered executable page and/or the like. This may allow the decoy endpoint to gather forensic data of the attack vector in order to, for example, characterize the attack vector, detect potential threats, identify attack patterns, estimate attack objectives and/or the like. The decoy endpoint may employ the access privileges granting and removing to control the execution flow of the unregistered executable page(s) while deceiving the attacker to believe he is not detected. For example, the adjusted page fault handler of the decoy endpoint OS may be configured to remove write privileges from one or more registered executable pages such that in case the malicious code tries to access the registered executable page(s) a page fault event is triggered. Such an access may be done by the malicious code to alter an originally registered executable page after loaded to memory. The page fault event naturally invokes the adjusted page fault handler which may then follow the execution flow of the malicious code (unregistered executable page(s)) while granting again the write privileges to allow the malicious code to continue its execution normally thus the malicious code is deceived to believe it is not detected.

For such deception implementation(s), the adjusted page fault handler may optionally remove (deny) write privileges from the executable page(s) in order to trigger another page fault in case a write access is initiated to these executable pages(s). This may prevent breaching the security chain by preventing a potential malicious executable page from copying (loading) a registered executable page, altering it while in memory to contain malicious code and executing it. This may further allow monitoring self-changing code while it is changing, a prominent defense technique which may be used by potential malicious attackers to hide malicious code.

Registering (marking), monitoring and detecting execution of unregistered code at the page level may present significant advantages. Typically, registration of code also known as signing code relates to high level executable software entities, such as software modules (e.g. application, agent, tool, script, etc.), code segments and/or the like. Such registration (code signing) implementations may present major degradation to the execution flow and performance and in some cases may need to be done offline since very large segments of code may need to be validated which may lead to significant performance hit. Moreover, some software modules may include self-changing code (e.g. JavaScript, etc.) which may need to be monitored on page level since the code may change after it was registered.

Monitoring and detecting the unregistered code at the page level on the other hand may be done in runtime as the page size is finite and typically small (e.g. 4096 bytes). This is further complemented by using fast authentication algorithms, for example, hash functions such as SHA-1, SHA-256 and/or the like which may calculate the authentication value fast thus imposing only insignificantly low performance degradation.

Moreover, monitoring and detecting the unregistered executable pages at the page level may allow detection of alterations to the code as may be done, for example, by the self-changing code and/or by malicious code altering previously registered executable pages. This may be further supported by removing and re-assigning the access privileges to the executable pages during the registration and runtime phases.

Furthermore, with respect to the deception implementations, currently existing cyber security systems and methods typically simply block execution of unsigned (unregistered) software modules. The decoy endpoint(s) on the other hand, by monitoring and detecting the code execution at page level, may allow normal execution of potentially malicious code, i.e. the unregistered executable pages thus deceiving the attacker believe he is not detected. However, simultaneously and transparently to the attacker, the decoy endpoint may constantly monitor the execution activity of the malicious code and collect forensic data which may be later analyzed.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages.

The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

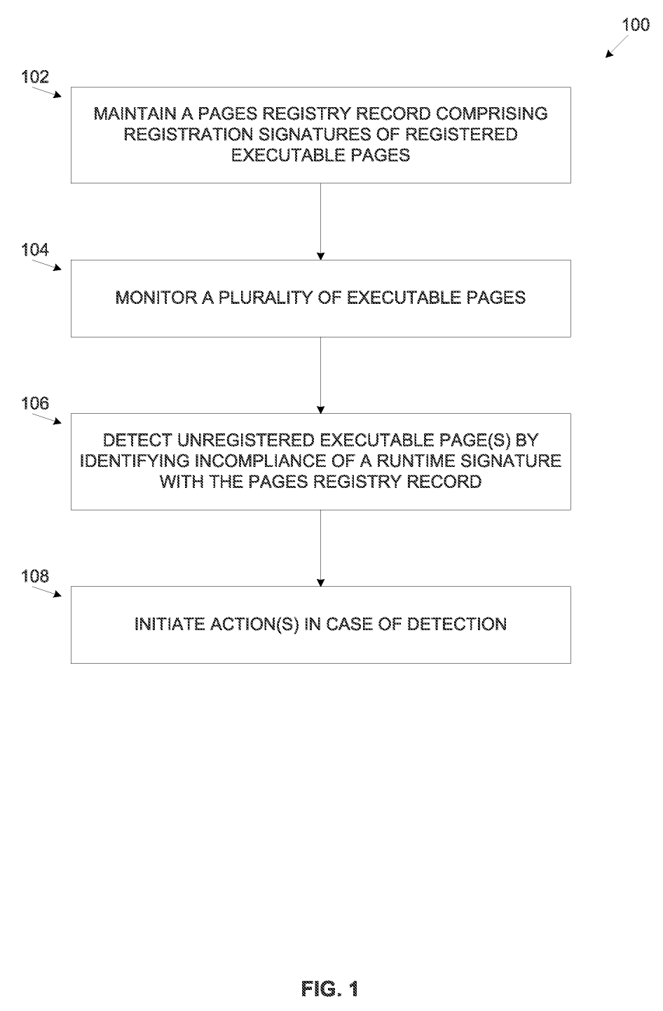

Referring now to the drawings, FIG. 1 is a flowchart of an exemplary process of detecting execution of unregistered code in a protected networked system, according to some embodiments of the present invention. A process 100 is executed at a protected networked system (protected network) to detect execution of unregistered (unapproved) software code. The protected networked system may be, for example, an organization network, an institution network and/or the like in which registered software code, for example, applications(s), tool(s), service(s), agent(s), script(s) and/or the like is approved for execution by one or more endpoints of the protected networked system. Naturally, the approved software code is verified and does not include malicious code.

The approved software code is first registered (signed). The approved software code may be analyzed to identify a plurality of executable pages constituting the approved software code. Once identified, a registration signature may be generated for each of the executable pages and/or for a subset of executable pages. The registration signature may include, for example, an ID of a respective executable page and an authentication value (e.g. checksum) generated by, for example, applying one or more hash functions to the executable page. The registration signatures are updated in a pages registry record, for example, a database, a list, a table and/or the like which is stored in the protected networked system.

At each of the endpoints, during runtime, a plurality of executable pages are monitored at the page management level, for example, by hooking, replacing, adjusting and/or adapting a page fault handler in a kernel of an OS executed by the endpoint. While the page fault handler loads the executable pages, maps them and/or prepares the executable pages for execution, a runtime signature is generated for each executable page and/or subset of executable page. The runtime signature follows the same structure and content as the registration signature. Naturally, during runtime, the same hash function(s) as used to calculate the hash values of the registered signatures are used to calculate the hash value of the runtime signature.

The runtime signature generated (calculated) for each executable page handled by the page fault handler is checked against the registration signatures in the pages registry record to check for a match. The match indicates that a matching registration signature is found in the pages registry record having the same ID and an equal value as the value calculated for the runtime signature.

In case the runtime signature of a respective executable page matches one of the registration signatures in the pages registry record, the respective executable page is considered as approved executable page and may execute normally. However in case the runtime signature of the respective executable page does not match any of the registration signatures in the pages registry record, the respective executable page is identified as an unregistered executable page which may potentially be a malicious code page. In such case, while the unregistered executable page may be allowed to execute normally, one or more actions may be taken, for example, generating an alert, monitoring execution activity of the respective unregistered executable page and/or the like. Optionally, the execution of the respective unregistered executable page may be prevented.

In some embodiments of the present invention, a decoy endpoint utilizes the registration, monitoring and detection of the unregistered executable pages, which may potentially contain malicious code in order to detect potential exposure of a protected networked system to a cyber-attack.

Optionally, access privileges, for example, execution and/or write privileges are granted and/or denied for the executable pages during one or more phases of the process 100.

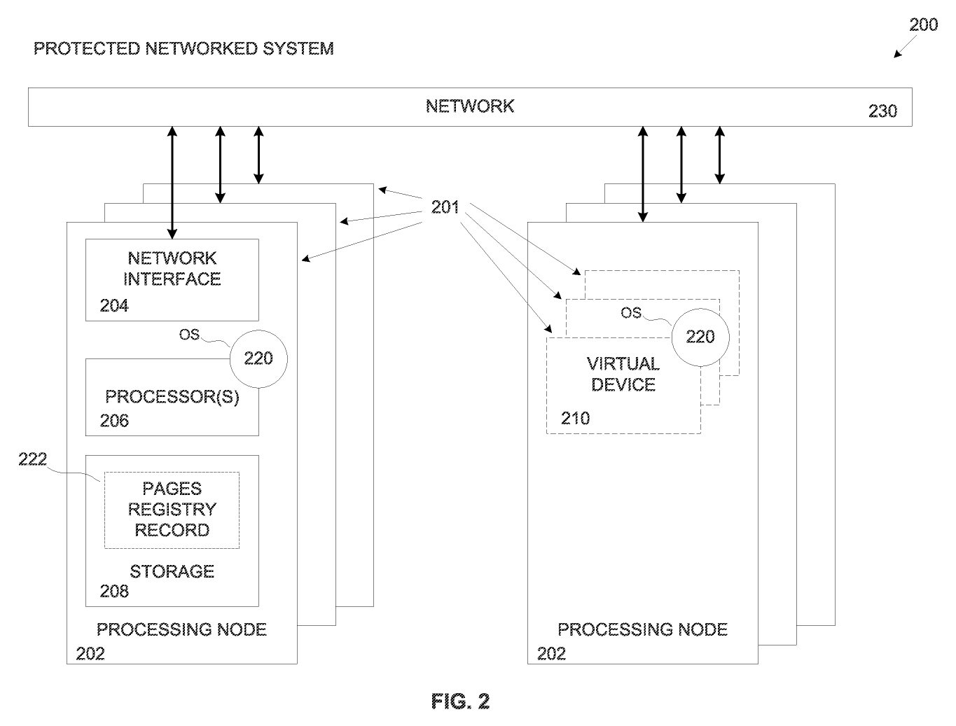

Reference is also made to FIG. 2, which is a schematic illustration of an exemplary system for detecting execution of unregistered code in a protected networked system, according to some embodiments of the present invention. An exemplary protected networked system 200 comprises a plurality of endpoints 201 connected to a network 230 facilitated through one or more network infrastructures, for example, a local area network (LAN), a wide area network (WAN), a personal area network (PAN), a metropolitan area network (MAN) and/or the internet. The network 230 may facilitate communication among the endpoints 201 as well as with more or more external resources which are not part of the remote protected networked system. The protected networked system 200 may be a centralized single location networked system where all the endpoints 201 are on premises. Optionally, the protected networked system 200 is a distributed network in which the endpoints 201 may be located at multiple physical and/or geographical locations or sites.

One or more of the endpoints 201 may be utilized by processing nodes 202, i.e. physical devices comprising one or more processor(s), for example, a computer, a workstation, a server, a cluster of processing nodes, a network node, a Smartphone, a tablet, a modem, a hub, a bridge, a switch, a router, a printer and/or any network connected device having one or more processors. The processing node 202 comprises a network interface 204 for connecting to the network 230, a processor(s) 206 and a storage 208. The processor(s) 206, homogenous or heterogeneous, may include one or more processors arranged for parallel processing, as clusters and/or as one or more multi core processor(s). The storage 208 may include one or more non-transitory persistent storage devices, for example, a hard drive, a Flash array and/or the like. The storage 208 may further comprise one or more network storage devices, for example, a storage server, a network accessible storage (NAS), a network drive, and/or the like. The storage 208 may also include one or more volatile devices, for example, a Random Access Memory (RAM) component and/or the like.

The storage 208 may store one or more software modules, for example, an OS, an application, a tool, an agent, a service, a script and/or the like each comprising a plurality of program instructions that may be executed by the processor(s) 206 from the storage 208. Typically, the processor(s) 206 executes one or more OSs 220 which provides an execution environment for one or more of the software modules such as, for example, the application(s), the service(s), the agent(s), the script(s) and/or the like. One or more data structures may be stored in the storage 208, for example, a file, a database, a list, a table, an array and/or the like. As such, the storage 208 may be used to store a pages registry record 222, for example, a database, a list, a table, an array and/or the like.

In some embodiments, one or more of the endpoints 201 may be utilized as one or more virtual devices 210, for example, a Virtual Machine (VM) executed by one or more of the processing nodes 202. The virtual device 210 may provide an abstracted and platform-dependent and/or independent program execution environment. The virtual device 210 may imitate operation of the dedicated hardware components, operate in a physical system environment and/or operate in a virtualized system environment. The virtual devices 210 may also be instantiated through one or more cloud services, for example, Amazon Web Service (AWS), Google Cloud, Microsoft Azure and/or the like. The virtual devices may be utilized as system VMs, process VMs, application VMs and/or other virtualized implementations such as, for example, Elastic Sky X (ESXi), XEN, Kernel-based Virtual Machine (KVM) and/or the like. In such deployment scenario(s), the virtual device(s) 210 may execute the OS 220 and access the hardware resources of the hosting processing node 202, for example, the network interface 204, the storage 208 and/or the like. The virtual devices 210 may also be provided as a service through one or more hosted services available by the cloud service(s), for example, software as a service (SaaS), platform as a service (PaaS), Network as a Service (Naas) and/or the like.

Optionally, one or more of the endpoints 201 is a decoy endpoint creating, maintaining and/or adapting a deception environment emulating a (real) processing environment within the protected networked system 200. The decoy endpoint may execute one or more deception resources, for example, a decoy OS, a deception application, a deception service, a deception website, a deception database and/or the like that may be created, configured and/or executed by the processor(s) 206 to form the deception environment.

As shown at 102, the process 100 starts with registration (signing) of the approved software code for one or more of the endpoints 201 and creating and/or maintaining the pages registry record 222. One or more software modules, for example, a registration tool may be used to create the pages registry record 222 for registering executable pages of software modules approved for execution in the protected network.

The pages registry record 222 may be created to reflect the software code environment approved for each of the endpoints 201 such that an approved software environment may be specifically defined for one or more of the endpoints 201.

The registration tool may traverse the file system of the endpoint(s) 201 and parse the detected software modules to identify executable code segments, in particular executable pages and/or subsets of executable pages. It is assumed that while creating the pages registry record 222, the installed software code (modules) which is detected in the file system is approved for execution by the endpoints 201 and may therefore be registered, i.e. signed. An executable page is the smallest executable building block and its size is traditionally defined and/or set according to the processing and/or memory architecture of the execution environment. The page size may generally depend on, for example, characteristics of the hardware platform, in particular, the architecture of the processor(s) 206 (and cache), the implementation of the virtual device 210 and/or the architecture of the OS 220. The page size is typically small, for example, 4096 bytes as traditionally defined for most modern processing platforms.

The registration tool may generate a registration signature for each of the registered executable pages. Each of the registration signatures may include an ID for a respective one of the registered executable pages and an associated calculated value for authenticating the registered executable page content. The registration tool may update the registration signatures in the pages registry record 222. The value used for authenticating the executable page content may be, for example, a hash value calculated by the registration tool by applying one or more hash functions, for example, SHA-1, SHA-256 and/or the like to calculate the hash value for the executable pages.

The pages registry record 222 may then be locally stored by one or more of the endpoints 201 and/or the pages registry record 222 may be stored in a network location within the protected networked system 200 accessible by one or more of the endpoints 201 over the network 230.

Once the pages registry record 222 is created, the entire approved software environment comprising the approved software modules may be deployed, installed and/or approved in one or more of the endpoints 201.

Optionally, one or more software modules may be approved for execution after deployment of the software code (i.e. approved software modules). In such case the registration tool may be used to create the registration signature for the executable pages detected in the newly added software module(s) and update the pages registry record 222 accordingly.

Optionally, during the registration phase, the registration tool is used to remove execution privileges from one or more of the registered executable pages. This may be done, for example, for one or more of the endpoints 201 utilizing a processor(s) such as the processor(s) 206 which is based on Intel x86 architecture in order to trigger a page fault event during runtime for each of the registered executable pages. In some implementation scenarios mainly depending on the architecture of the processor(s) 206, the registration tool may remove the execution privileges from all of the registered executable pages while in other implementation scenarios, the execution privileges may be removed from only a subset of the registered executable pages.

As shown at 104, during runtime at each of one or more of the endpoints 201, a plurality of executable pages are monitored at page level, in particular, the monitored executable pages are those which are prepared for execution by the respective endpoint 201. The page level monitoring is done at the page management level of the OS 220 providing the execution environment for the executable software, i.e. the executable pages. This may be utilized, for example, by adjusting and/or adapting an original page fault handler routine which is executed in the kernel space of the OS 220. Optionally, the OS 220 may be adapted such that the adjusted page fault handler replaces the original page fault handler in the kernel by hooking the adjusted page fault handler to the physical layer page fault interrupt (e.g. vector 14 for Intel x86 architecture) instead of the original page fault handler which is typically hooked to this interrupt. The page fault routine is triggered whenever a page fault event is detected in which a page that needs to be executed is not currently mapped for execution by the MMU of the processor(s) 206 into the virtual address space of the executing software module. The page fault handler may therefore prepare the requested executable page for execution by creating an entry for that requested executable page in the MMU to point to the page in memory and indicate that the page is loaded in memory. Preparing the requested executable page for execution may also include assigning execution privileges to the requested executable page. As described for step 102, in some optional implementations, the execution privileges are removed from one or more of the registered executable pages during the registration process. As such, whenever such a registered executable page is requested for execution, a page fault may be triggered as the requested executable page is not currently allowed for execution.

The adjusted page fault handler routine of the OS 220 may therefore be configured to identify a plurality of pages, in particular executable pages prepared by the page fault handler for execution.

As shown in 106, the adjusted page fault handler may generate in runtime a runtime signature for each of the detected executable pages. The structure of the runtime signature may follow the structure of the registration signature, i.e. comprising the ID of a respective detected executable page and the authentication value calculated (in runtime) for that detected executable page. Naturally, to calculate the authentication value for each detected executable page, the adjusted page fault handler may apply the same method(s), for example, the hash function(s) used during the registration phase as described in step 102.

The adjusted page fault handler may check compliance of the runtime signature against the pages registry record 222 to evaluate whether each of the detected executable pages (prepared for execution) is approved. The adjusted page fault handler may search the pages registry record 222 for a registration signature comprising the same ID as the ID of the detected executable page. In case the ID of the detected executable page matches an ID of a registered executable page, it means that the detected executable page was originally approved during the registration phase. However, it is possible that since the registration phase, the detected executable page was altered, manipulated and/or the like which may present a potential security threat. In order to verify the detected executable page is similar to the corresponding registered executable page originally registered (signed), the adjusted page fault handler may compare the authentication value calculated in runtime (available in the runtime signature) to the authentication value in the registration signature of the corresponding registered executable page. In case the authentication value in the runtime signature matches the authentication value in the registration signature of the respective registered executable page, the detected executable page is indeed approved for execution. On the other hand, the detected executable page is not an approved page in case either the ID of the detected executable page is absent (not fond) in the pages registry record 222 or the authentication value in the runtime signature does not match the authentication value in the runtime signature associated with the corresponding registered executable page.

Thus, based on the check of the runtime signature against the pages registry record 222, the adjusted page fault handler may detect one or more unregistered executable pages.

As shown in 108, following detection of the unregistered executable page(s), one or more actions may be initiated, for example, by the adjusted page fault handler. The action(s) initiated by the adjusted page fault handler may include, for example, generating an alert, monitoring execution activity of the respective unregistered executable page and/or the like. Optionally, the adjusted page fault handler may prevent execution of one or more of the unregistered executable pages. Additionally and/or alternative, at detection of the unregistered executable page(s), the adjusted page fault handler may trigger execution of another software module, for example, a script, an application, an agent, a tool and/or the like which may initiate one or more of the actions.

Optionally, the alert and/or activity information regarding the unregistered executable page(s) are directed to a main security management unit, for example, a server. The alert and/or the activity information may further be presented to one or more users, for example, an Information Technology (IT) officer, a regular user and/or the like. This may allow the user(s) to monitor which software code is being executed and how many times it has been executed.

Optionally, in case the execution privileges were previously removed from the detected executable page(s), the adjusted page fault handler may grant execution privileges to the detected executable page(s) in order to allow its execution.

As discussed before, in some embodiments the endpoint 201 is a decoy endpoint. For the decoy endpoint, it may be desired to allow the unregistered executable page(s) to execute in order not alert the malicious code and/or attacker about the detection while further monitoring the execution activity of the unregistered executable page(s) in order to gather forensic data. For such deception implementation(s), the adjusted page fault handler may optionally remove (deny) write privileges from the detected executable page(s). This may be done in order to trigger another page fault in case a write access is done to a respective one of the detected executable pages(s). This may prevent breaching the security chain by preventing a potential malicious executable page from copying (loading) a registered executable page, altering it while in memory to contain malicious code and executing it. Removing the write privileges may further allow monitoring self-changing code while it is changing, a prominent defense technique which may be used by potential malicious attackers to hide malicious code.

In order to monitor the execution activity of the unregistered executable page(s), the adjusted page fault handler of the OS kernel executed by the decoy endpoint may alternately remove and grant the write and/or execution privileges to the unregistered executable page(s). This may be done in order to deceive the potential attacker to believe the attack is not detected while at the same the execution activity may be controlled and monitored to collect the forensic data.

Optionally, one or more of the detection events in which the unregistered executable page is detected are logged. This may also be of major benefit for the decoy endpoint to allow collecting statistics on which unregistered executable pages are executed, which software modules are the unregistered executable pages part of, at what times the unregistered executable pages were executed, how many times the unregistered executable pages were executed and/or the like. Optionally, the detection events and/or statistics are analyzed to identify one or more execution patterns of one or more of the unregistered executable page. This may allow characterizing potential malicious attackers, attack vectors and/or the like.

Monitoring and detecting the execution of the unregistered executable pages may allow tracking and identifying the execution patterns of the unregistered executable pages which may be indicative of the execution patterns of the higher level software modules consisting the unregistered executable pages. This may be useful for a plurality of application, uses and/or deployments. For example, assuming a certain application and/or part thereof is provided in a pay-per-use charging model in which one or more users of the protected networked system 200, for example, the IT person, an accounting person, an operator, and/or the like need to maintain a book keeping count of the number of invocations and/or execution events of the pay-per-use application. To achieve this, the executable pages of the pay-per-use application may be designated as unregistered executable pages which are constantly monitored and tracked. As part of the actions initiated at detection of the execution of the unregistered executable pages the invocation/execution count may be maintained. Moreover, assuming only some of the features of the application require the pay-per-use payment while other features are free. In such case, only the executable pages of the pay-per-use modules may be designated as unregistered so the book keeping may be maintained for the pay-per-use modules.

Moreover, as the execution of the unregistered executable pages may be monitored on each of the endpoints 201 separately, the execution of the pay-per-use application(s) and/or part thereof may be monitored on user basis, or more accurately on endpoint basis. This may allow distributing the application(s) freely while monitoring the execution events per user to maintain user lists logging the number of execution events per user in order to charge each user accordingly. In particular, in case of the protected networked system 200, the pay-per-use application(s) may be provided, for example, by an external vendor such that the application(s) are not part of the original code base deployed to the endpoints 201. As such, the executable pages of the pay-per-use application(s) may be considered as unregistered executable pages since they are not registered in the pages registry record 222 and therefore their execution is detected and may be logged.

In another exemplary use case, detection and logging of the execution of the unregistered executable pages may be applied for testing, debugging, validation and/or verification of software module(s). For example, the executable pages of a certain application and/or part thereof which is being evaluated and/or tested may be marked as unregistered and as such may be monitored to detect the execution events of its unregistered executable pages. This may allow identifying the execution patterns as well as the context of the execution which may be analyzed to detect flaws, bugs and/or failures of the tested application and/or part thereof. Analyzing the execution patterns and/or context may be of particular benefit for detecting interaction bugs in which the application code interacts with other software modules. For example, assuming a certain bug is identified to appear only in case of a certain execution flow of a certain code segment, analysis of the context may allow focusing on the interaction between the interacting code segments to isolate the certain bug.

It is expected that during the life of a patent maturing from this application many relevant systems, methods and computer programs will be developed and the scope of the terms endpoint and virtual machine are intended to include all such new technologies a priori.

As used herein the term “about” refers to ±10%.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

The word “exemplary” is used herein to mean “serving as an example, an instance or an illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. A computer implemented method of detecting execution of unregistered code in a protected networked system, comprising:
maintaining a pages registry record in a storage of an endpoint in a protected networked system, the pages registry record comprising a registration signature for each of a plurality of registered executable pages;
monitoring a plurality of executable pages at a page management level using an adjusted page fault handler of an operating system kernel executed by at least one processor of the endpoint;
detecting at least one unregistered executable page by identifying incompliance of a runtime signature calculated in runtime for the at least one unregistered executable page with a respective registration signature stored in the pages registry record; and
initiating at least one action in case of the detection of the at least one unregistered executable page.

2. The computer implemented method of claim 1, wherein the plurality of registered executable pages are identified by parsing a plurality of executable code segments of a plurality of software modules approved for execution in the protected network.

3. The computer implemented method of claim 1, wherein the registration signature of each of the plurality of registered executable pages comprises at least an identification (ID) of a respective one of the plurality of registered executable pages and an authentication value calculated by applying at least one hash function to the respective executable page.

4. The computer implemented method of claim 1, wherein the monitoring, the detecting and the initiating is controlled by an adjusted page fault handler replacing a page fault handler of the operating system.

5. The computer implemented method of claim 1, wherein the incompliance comprising at least one of: absence of an ID of the at least one unregistered executable page in the pages registry record and an authentication value in the runtime signature not matching the authentication value in the respective registration signature.

6. The computer implemented method of claim 1, further comprising removing execution privileges from at least one of the plurality of executable pages as part of the maintaining.

7. The computer implemented method of claim 6, further comprising granting the execution privileges to the at least one executable page after the identifying.

8. The computer implemented method of claim 1, further comprising removing write privileges from at least one of the plurality of executable pages prior to the execution.

9. The computer implemented method of claim 1, wherein the at least one action is a member of a group consisting of: generating an alert, monitoring execution activity of the at least one unregistered executable page and preventing execution of the at least one unregistered executable page.

10. The computer implemented method of claim 1, further comprising updating the pages registry record with the registration signature generated for at least one executable page of at least one approved software module added to the protected networked system.

11. The computer implemented method of claim 1, further comprising logging a plurality of detection events in which the at least one unregistered executable page is detected.

12. The computer implemented method of claim 11, further comprising analyzing the plurality of detection events to identify at least one execution pattern of the at least one unregistered executable page.

13. The computer implemented method of claim 1, wherein the endpoint is a member of a group consisting of: a physical device comprising at least one processor and a virtual machine.

14. The computer implemented method of claim 1, wherein the endpoint is a decoy endpoint adapted to maintain a deception environment of the protected networked system.

15. A system for detecting execution of unregistered code in a protected networked system, comprising:
a storage storing a code storing a pages registry record comprising a registration signature for each of a plurality of registered executable pages; and
at least one processor of an endpoint in a protected networked system, the at least one processor is coupled to the storage for executing the stored code, the code comprising:
code instructions to monitor a plurality of executable pages at a page management level using an adjusted page fault handler of an operating system kernel executed by the at least one processor;
code instructions to detect at least one unregistered executable page by identifying incompliance of a runtime signature calculated in runtime for the at least one unregistered executable page with a respective registration signature stored in the pages registry record; and
code instructions to initiate at least one action in case of the detection of the at least one unregistered executable page.
